(19) United States
(12) Patent Application Publication
(10) Pub. No.: US 2011/0229764 A1
(43) Pub. Date: Sep. 22, 2011

(54) POWER STORAGE DEVICE AND MANUFACTURING METHOD THEREOF

(75) Inventors: Takahiro KAWAKAMI, Atsugi (JP); Masaki YAMAKAJI, Atsugi (JP); Nadine TAKAHASHI, Yamato (JP)

(73) Assignee: SEMICONDUCTOR ENERGY LABORATORY CO., LTD., Atsugi-shi (JP)

(21) Appl. No.: 13/044,155

(22) Filed: Mar. 9, 2011

(30) Foreign Application Priority Data
Mar. 19, 2010 (JP) 2010-065101

(51) Int. Cl. H01M 4/136; H01M 4/139

(52) U.S. Cl. 429/221; 427/77

(57) ABSTRACT

A power storage device comprising a positive electrode which includes in a positive electrode active material layer, lithium iron phosphate particles whose surface is supported by a carbon material and whose half width of the X-ray diffraction peak is less than or equal to 0.17°, or greater than or equal to 0.13° and less than or equal to 0.165′ or whose particle size is greater than or equal to 20 nm and less than 50 nm or greater than or equal to 30 nm and less than 40 nm; or a method for manufacturing a power storage device comprising the steps of mixing the lithium iron phosphate particles, a conduction auxiliary agent, and a binder so as to be a paste, and applying the paste on a current collector, thereby manufacturing a positive electrode.

### TECHNICAL FIELD

One embodiment of the disclosed invention relates to a power storage device and a manufacturing method thereof.

### BACKGROUND ART

In recent years, with an increase of environmental engineering, development of power generating technologies which pose less burden on the environment (e.g., solar power generation) than conventional power generation methods has been actively conducted. Concurrently with the development of power generation technology, development of power storage technology has also been underway.

A power storage technology includes, for instance, a lithium ion secondary battery. Lithium ion secondary batteries are widely prevalent since their energy density is high and because they are well suited for miniaturization. As a material used for a positive electrode of the lithium ion secondary battery, there is lithium iron phosphate (LiFePO₄) having an olivine structure, for example (see Patent Document 1).

Lithium iron phosphate (LiFePO₄) has the advantages of having a stable structure even when charge and discharge are performed and having a high level of safety.

### REFERENCE

[Patent Document 1] Japanese Published Patent Application No. 2008-257894

### DISCLOSURE OF INVENTION

However, lithium iron phosphate (LiFePO₄) having such a large capacitance has the disadvantages of high bulk resistivity (electric conductivity of lithium iron phosphate is about 6.8×10⁻⁹ S/cm). The bulk resistivity is resistivity of lithium iron phosphate itself. The bulk resistivity depends on a crystal structure of lithium iron phosphate and an element which forms lithium iron phosphate. “High bulk resistivity” means that electronic conduction is bad.

Because lithium iron phosphate has high bulk resistivity, charge and discharge of a power storage device in which lithium iron phosphate is used as a positive electrode active material may be slow.

In addition, lithium iron phosphate is disadvantageous in that diffusion of lithium (Li) ions is slow. The reason for slow ion diffusion is that in lithium iron phosphate having an olivine structure, lithium ions diffuse one-dimensionally in a <010> direction. In other words, lithium ions diffuse only in one direction.

The theoretical capacity of lithium iron phosphate (LiFePO₄) is 170 mAh/g. This theoretical capacity is obtained from the crystal structure of lithium iron phosphate by calculation. However, because diffusion of lithium ions in a crystal of lithium iron phosphate is slow, it is difficult for lithium ions to reach the inside of the crystal of lithium iron phosphate. Therefore, in the power storage device in which lithium iron phosphate is used as a positive electrode active material, only a capacitance smaller than the theoretical capacity can be obtained.

In view of the foregoing problems, it is an object of one embodiment of the disclosed invention to obtain a power storage device with rapid charge and discharge.

It is another object of one embodiment of the disclosed invention to accelerate diffusion of lithium ions.

It is another object of one embodiment of the disclosed invention to obtain a power storage device having a large capacitance.

The particle size of lithium iron phosphate is nano-sized. Accordingly, the diffusion length of lithium ions can be shortened in lithium iron phosphate. Thus, the capacitance of a power storage device can be increased.

When a positive electrode is manufactured using a lithium iron phosphate particle with such a small particle size, lithium iron phosphate particles are aggregated. However, by using a carbon material as a support on a surface of lithium iron phosphate particles with a small particle size, aggregation of lithium iron phosphate particles can be suppressed. By suppressing the aggregation of lithium iron phosphate particles, the resistance of the whole positive electrode can be decreased. Therefore, rapid charge and discharge of the power storage device can be achieved. In this specification, “lithium iron phosphate particles whose surface is supported by a carbon material” also means that lithium iron phosphate particles are carbon-coated. Further, in this specification, “lithium iron phosphate particles whose surface is supported by a carbon material” means that the surface of lithium iron phosphate particles is covered with a carbon material even though the surface of the lithium iron phosphate particles is not entirely covered with the carbon material.

One embodiment of the disclosed invention relates to a power storage device comprising a positive electrode which includes in a positive electrode active material layer, a lithium iron phosphate particle whose surface is supported by a carbon material and whose half width of an X-ray diffraction peak is less than or equal to 0.17°.

One embodiment of the present invention relates to a power storage device comprising a positive electrode which includes in a positive electrode active material layer, a lithium iron phosphate particle whose surface is supported by a carbon material and whose half width of an X-ray diffraction peak is greater than or equal to 0.13° and less than or equal to 0.165°.

One embodiment of the disclosed invention relates to a power storage device comprising a positive electrode which includes in a positive electrode active material layer, a lithium iron phosphate particle whose surface is supported by a carbon material and whose particle size is greater than or equal to 20 nm and less than 50 nm.

One embodiment of the disclosed invention relates to a power storage device comprising a positive electrode which includes in a positive electrode active material layer, a lithium iron phosphate particle whose surface is supported by a carbon material and whose particle size is greater than or equal to 30 nm and less than 40 nm.

One embodiment of the disclosed invention relates to a method for manufacturing a power storage device comprising the steps of mixing a lithium iron phosphate particle whose surface is supported by a carbon material and whose half width of an X-ray diffraction peak is less than or equal to 0.17°, a conduction auxiliary agent, and a binder so as to be a paste, and applying the paste on a current collector, thereby manufacturing a positive electrode.

One embodiment of the disclosed invention relates to a method for manufacturing a power storage device comprising the steps of mixing a lithium iron phosphate particle whose surface is supported by a carbon material and whose half width of an X-ray diffraction peak is greater than or equal to 0.13° and less than or equal to 0.165°, a conduction auxiliary agent, and a binder so as to be a paste, and applying the paste on a current collector, thereby manufacturing a positive electrode.

One embodiment of the disclosed invention relates to a method for manufacturing a power storage device comprising the steps of mixing a lithium iron phosphate particle whose surface is supported by a carbon material and whose particle size is greater than or equal to 20 nm and less than 50 nm, a conduction auxiliary agent, and a binder so as to be a paste, and applying the paste on a current collector, thereby manufacturing a positive electrode.

One embodiment of the disclosed invention relates to a method for manufacturing a power storage device comprising the steps of mixing a lithium iron phosphate particle whose surface is supported by a carbon material and whose particle size is greater than or equal to 30 nm and less than 40 nm, a conduction auxiliary agent, and a binder so as to be a paste, and applying the paste on a current collector, thereby manufacturing a positive electrode.

According to one embodiment of the disclosed invention, a power storage device with rapid charge and discharge can be obtained. Further, diffusion of lithium ions can be accelerated. Thus, a power storage device having a large capacitance can be obtained.

### BRIEF DESCRIPTION OF DRAWINGS

FIGS. 1A to 1C are SEM photographs of lithium iron phosphate particles whose surface is supported by a carbon material.

FIGS. 2A to 2C are SEM photographs of lithium iron phosphate particles.

FIGS. 3A to 3C are SEM photographs of lithium iron phosphate particles whose surface is supported by a carbon material.

FIGS. 4A to 4C are SEM photographs of lithium iron phosphate particles.

FIG. 5 is a graph showing a relation between a baking temperature and the specific surface area.

FIG. 6 is a graph showing a relation between a baking time and the specific surface area.

FIG. 7 is a graph showing a result of X-ray diffraction of lithium iron phosphate particles whose surface is supported by a carbon material.

FIG. 8 is a graph showing a result of X-ray diffraction of lithium iron phosphate particles.

FIG. 9 is a graph showing a result of X-ray diffraction of lithium iron phosphate particles whose surface is supported by a carbon material.

FIG. 10 is a graph showing a result of X-ray diffraction of lithium iron phosphate particles

FIGS. 11A to 11C are SEM photographs of lithium iron phosphate particles whose surface is supported by a carbon material.

FIG. 12 is a graph showing a relation between a baking temperature and a half width.

FIG. 13 is a graph showing a relation between baking time and a half width.

FIG. 14 is a graph showing a relation between the amount of glucose to be added and the specific surface area.

FIG. 15 is a graph showing a relation between a baking temperature and charge and discharge capacitance.

FIG. 16 is a graph showing a relation between a baking temperature and rate characteristics.

FIG. 17 is a graph showing a relation between baking time and charge and discharge capacitance.

FIG. 18 is a graph showing a relation between baking time and rate characteristics.

FIG. 19 is a graph showing a relation between the amount of glucose to be added and charge and discharge capacitance.

FIG. 20 is a graph showing a relation between the amount of glucose to be added and rate characteristics.

FIG. 21 is a graph showing a relation of charge and discharge capacitance between lithium iron phosphate particles whose surface is supported by a carbon material and lithium iron phosphate particles whose surface is not supported by a carbon material.

FIG. 22 is a graph showing a relation between a half width of the X-ray diffraction peak and discharge capacitance.

FIG. 23 is a graph showing a relation between the specific surface area and discharge capacitance.

FIG. 24 is a graph showing a relation between a half width of the X-ray diffraction peak and rate characteristics.

FIG. 25 is a graph showing a relation between the specific surface area and rate characteristics.

FIGS. 26A and 26B are diagrams showing a relation among a positive electrode active material layer, lithium iron phosphate particles, and crystal grains.

FIG. 27 is a diagram showing a structure of a secondary battery.

FIG. 28 is a graph showing a particle size distribution of lithium iron phosphate particles.

### BEST MODE FOR CARRYING OUT THE INVENTION

Embodiments of the invention disclosed in this specification will be hereinafter described with reference to the accompanying drawings. Note that the invention disclosed in this specification can be carried out in a variety of different modes, and it is easily understood by those skilled in the art that the modes and details of the invention disclosed in this specification can be changed in various ways without departing from the spirit and scope thereof. Therefore, the present invention is not construed as being limited to description of the embodiment mode and embodiments. Note that, in the drawings hereinafter shown, the same portions or portions having similar functions are denoted by the same reference numerals, and repeated description thereof will be omitted.

### Embodiment 1

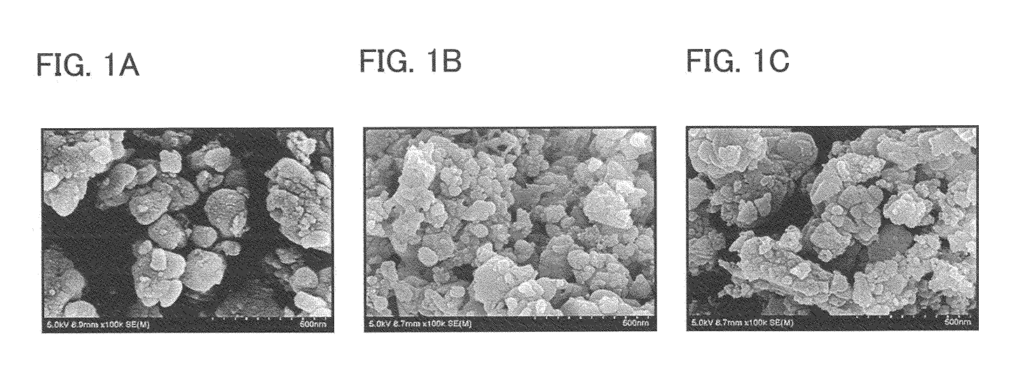

A power storage device of this embodiment and a method for manufacturing the power storage device are described with reference to FIGS. 1A to 1C, FIGS. 2A to 2C, FIGS. 3A to 3C, FIGS. 4A to 4C, FIG. 5, FIG. 6, FIG. 7, FIG. 8, FIG. 9, FIG. 10, FIGS. 11A to 11C, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIGS. 26A and 26B, FIG. 27, and FIG. 28.

In this embodiment, lithium iron phosphate (LiFePO₄) is used as a positive electrode active material of a secondary battery. Lithium iron phosphate, a manufacturing method thereof, and characteristics thereof are described below. Then, a secondary battery in which lithium iron phosphate is used as a positive electrode active material, a manufacturing method thereof, and characteristics thereof are described.

### <Manufacturing Method of Lithium Iron Phosphate Particle>

First, a manufacturing method of lithium iron phosphate (LiFePO₄) particles is described below.

As a material of lithium iron phosphate, lithium carbonate (Li₂CO₃), iron oxalate (FeC₂O₄), and ammonium dihydrogen phosphate (NH₄H₂PO₄) are mixed.

Lithium carbonate is a raw material for introducing lithium; iron oxalate is a raw material for introducing iron; and ammonium dihydrogen phosphate is a raw material for introducing phosphoric acid. The mixture of these materials is performed in first ball mill treatment.

The first ball mill treatment is performed in such a manner that, for example, acetone is added as a solvent, and a ball mill with a ball diameter of φ3 mm is rotated at 400 rpm (revolutions per minute) for 2 hours (time of revolution). By the first ball mill treatment, uniform mixture and miniaturization of the material are achieved, and a solid phase reaction is promoted.

From the above materials, lithium iron phosphate (LiFePO₄) is synthesized.

After the first ball mill treatment, the raw-material mixture is pressurized so as to improve contact between the mixed raw materials. With this pressurizing process, the reaction of the raw-material mixture is further promoted. Specifically, the raw-material mixture is shaped into pellets with a force of 1.47×10²N (150 kgf).

Next, the raw-material mixture which has been shaped into pellets is subjected to first baking. In this embodiment, as the first baking, the raw-material mixture which has been shaped into pellets is baked at 350° C. for 10 hours in a nitrogen (N₂) atmosphere.

After the first baking, the baked pellets are ground in a mortar or the like.

Here, a material which generates carbon is added to a sample whose surface is to be supported by a carbon material. Specifically, a substance which may generate conductive carbon by thermal decomposition (hereinafter referred to as a conductive carbon precursor) is added to the ground pellets. As the conductive carbon precursor, for example, a saccharide, more specifically, glucose is added. By adding the conductive carbon precursor and then conducting the following manufacturing process, a carbon material is supported on the surface of the lithium iron phosphate particles. That is, the lithium iron phosphate particles are carbon-coated.

By adding a saccharide as the conductive carbon precursor, a large number of hydroxy groups included in the saccharide strongly interact with the raw materials and the surface of lithium iron phosphate particles to be formed. Accordingly, crystal growth of the lithium iron phosphate particles is controlled. That is, with the use of the saccharide, an effect of imparting conductivity to the lithium iron phosphate particles can be obtained and crystal growth of the lithium iron phosphate particles can be controlled.

Further, in this embodiment, samples having different amounts of glucose are manufactured. The amount of glucose is 5 wt %, 10 wt %, and 15 wt %. Note that the amount of glucose of a reference sample is 10 wt %. The amount of glucose is 10 wt % in what follows unless otherwise specified.

Then, second ball mill treatment is performed on the ground pellets. The second ball mill treatment is performed under conditions similar to those of the first ball mill treatment.

After the second ball mill treatment, the raw-material mixture is shaped into pellets again. Then, the raw-material mixture which has been shaped into pellets again is subjected to second baking in a nitrogen atmosphere.

In this embodiment, samples in which a baking temperature and baking time of the second baking are changed are manufactured. The baking temperature is 400° C., 500° C., and 600° C. (for the baking time of 10 hours). In addition, the baking time is 3 hours, 5 hours, and 10 hours (at the baking temperature of 600° C.). Note that the baking temperature is 600° C. and the baking time is 10 hours in the reference sample. The baking temperature is 600° C. and the baking time is 10 hours in the following description unless otherwise specified.

After the second baking, the baked pellets are ground in a mortar or the like. Third ball mill treatment is performed on the ground pellets. The third ball mill treatment is performed in such a manner that, for example, acetone is added as a solvent, and a ball mill with a ball diameter of φ3 mm is rotated at 300 rpm (revolutions per minute) for 3 hours (time of revolution). Through the above manufacturing process, lithium iron phosphate particles are manufactured.

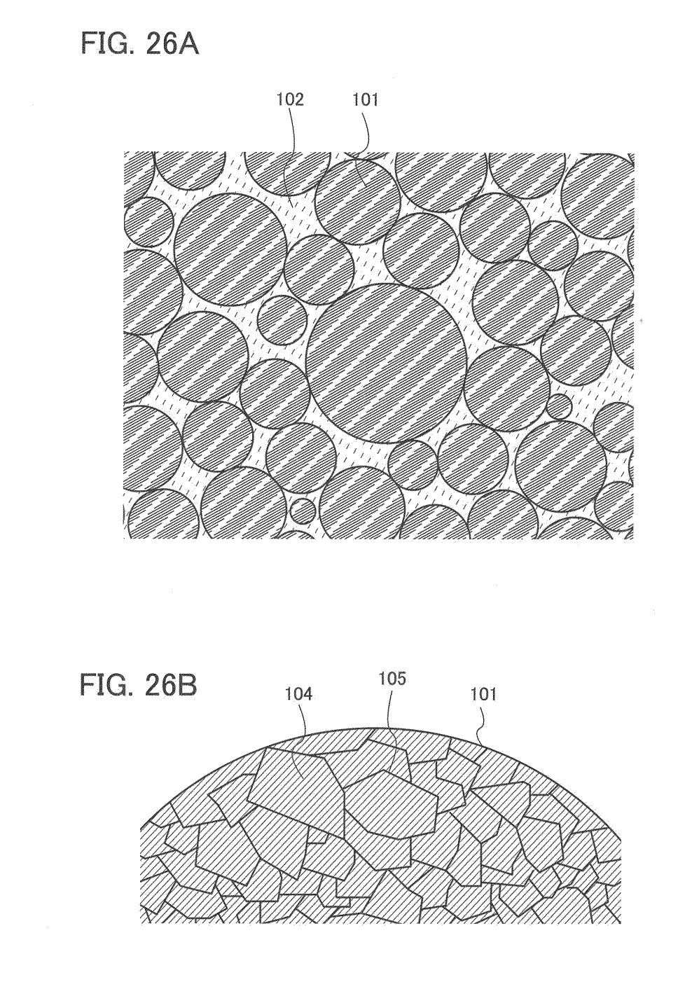

FIGS. 26A and 26B show a positional relation between lithium iron phosphate particles and crystal grains contained in the lithium iron phosphate particles. Note that carbon covering the lithium iron phosphate particles is not illustrated.

A lithium iron phosphate particle 101 is fixed by a binder 102 in a positive electrode active material layer described below. The lithium iron phosphate particle 101 includes a plurality of crystal grains 104. A grain boundary 105 exists between the adjacent crystal grains 104. The degree of crystallinity of crystal grains is shown by X-ray diffraction (XRD) and the particle size of the lithium iron phosphate is shown from the measurement of the specific surface area.

### <Evaluation of Lithium Iron Phosphate Particle>

As described above, lithium iron phosphate particles which are a positive electrode material are obtained. In this embodiment, first, characteristics of the obtained lithium iron phosphate particles are evaluated; next, a positive electrode is manufactured using the obtained lithium iron phosphate particles; and then characteristics of a battery using the positive electrode is evaluated.

### <Change by Baking Temperature>

As for the lithium iron phosphate particles which are manufactured with the baking temperature changed, the result of evaluation by X-ray diffraction, measurement of the specific surface area, and a SEM photograph is illustrated below.

### <Baking Temperature—X-Ray Diffraction>

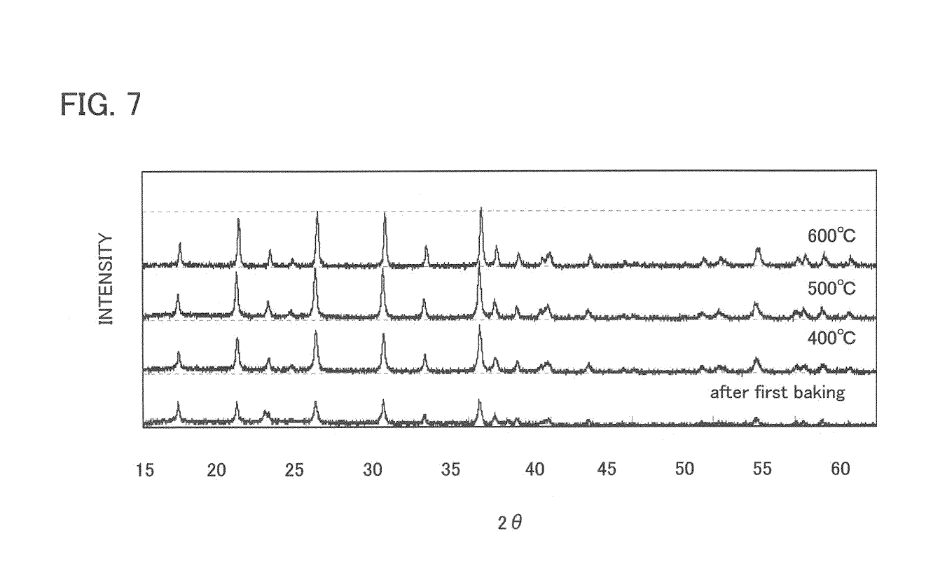

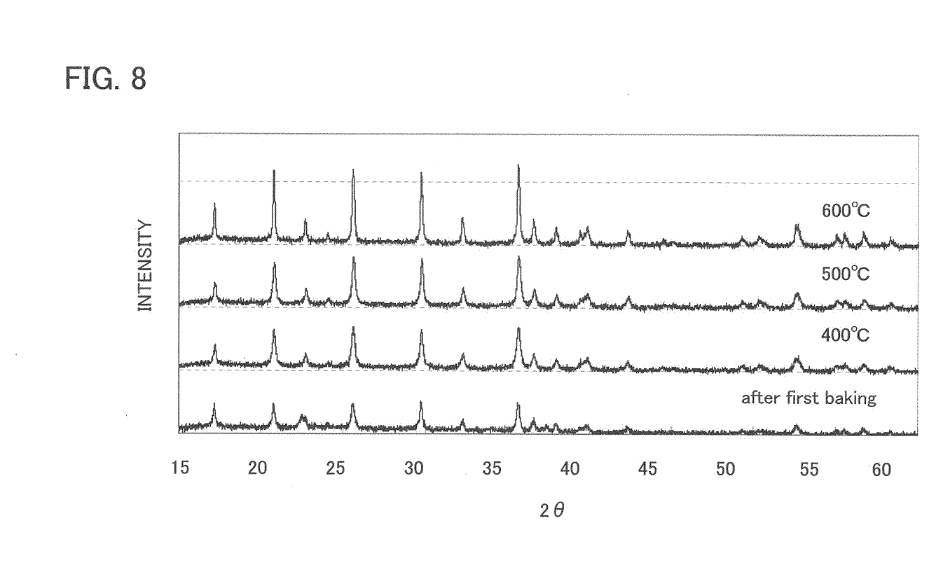

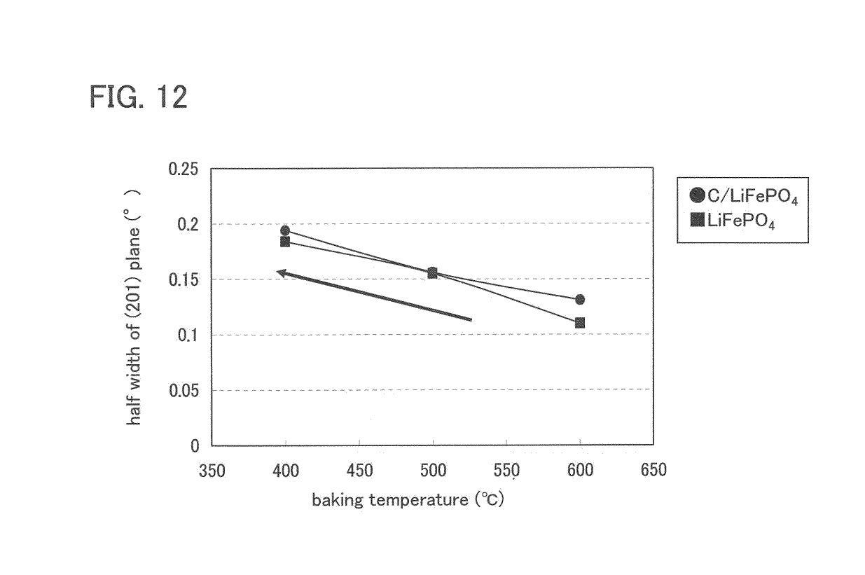

The result of X-ray diffraction of lithium iron phosphate particles manufactured with the baking temperature changed is illustrated in FIG. 7, FIG. 8, and FIG. 12.

FIG. 7 shows the result of X-ray diffraction of lithium iron phosphate particles whose surface is supported by a carbon material. In the second baking, the baking temperature is 400° C., 500° C., and 600° C. Note that the baking time is 10 hours.

In FIG. 7, a peak of 2θ=25° can be observed. This is the peak of lithium iron phosphate (201) plane. From this, it is confirmed that the samples measured by X-ray diffraction of FIG. 7 are olivine-type lithium iron phosphate having the (201) plane.

FIG. 8 shows the result of X-ray diffraction of lithium iron phosphate particles whose surface is not supported by a carbon material. In the second baking, the baking temperature is 400° C., 500° C., and 600° C. Note that the baking time is 10 hours.

In FIG. 8, a peak of 2θ=25° can be observed. This is a peak of lithium iron phosphate (201) plane. From this, it is confirmed that the samples measured by X-ray diffraction of FIG. 8 are olivine-type lithium iron phosphate having the (201) plane.

FIG. 12 shows a relation between a baking temperature (X axis) which is set at 400° C., 500° C., or 600° C. and a half width of the peak of 2θ=25° (Y axis) in the case of lithium iron phosphate particles whose surface is supported by a carbon material (C/LiFePO₄ indicated by black circles) and in the case of lithium iron phosphate particles whose surface is not supported by a carbon material (LiFePO₄ indicated by black squares).

A half width of the X-ray diffraction peak shows the degree of crystallinity (the level of crystallinity). Note that a small half width means that the peak is sharp and a large number of crystal grains having uniform crystal orientation are contained. That is, crystallinity is high. On the contrary, a large half width means that the peak is broad and a large number of crystal grains having various crystal orientations are contained. That is, crystallinity is low.

In FIG. 12, the lower the baking temperature is, the larger the half width becomes. That is, the lower the baking temperature is, the lower the crystallinity becomes. Note that the relation between the half width and the characteristics of a secondary battery is described below.

### <Baking Temperature-SEM Photograph>

FIGS. 1A to 1C show SEM photographs of lithium iron phosphate particles whose surface is supported by a carbon material and which are manufactured in such a way that the baking temperature in the second baking is set at 600° C., 500° C., and 400° C.

From FIGS. 1A to 1C, it can be confirmed that the lower the baking temperature is, the smaller the particle size of lithium iron phosphate becomes.

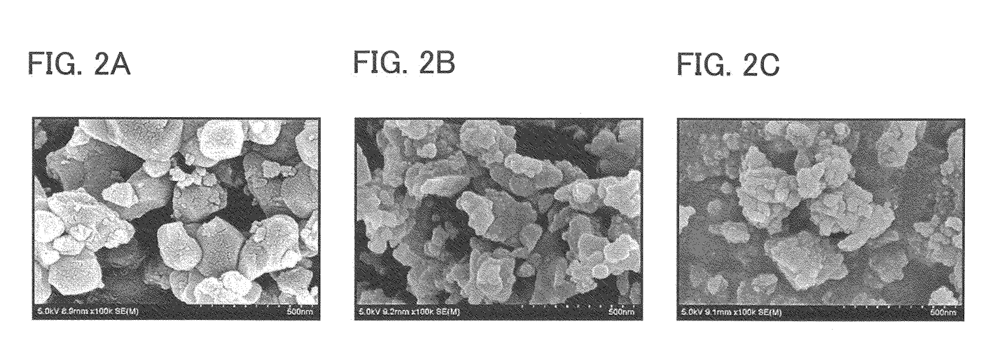

FIGS. 2A to 2C show SEM photographs of lithium iron phosphate particles whose surface is not supported by a carbon material and which are manufactured in such a way that the baking temperature in the second baking is set at 600° C., 500° C., and 400° C.

From FIGS. 2A to 2C, it can be confirmed that the lower the baking temperature is, the smaller the particle size of lithium iron phosphate becomes.

### <Baking Temperature—Specific Surface Area>

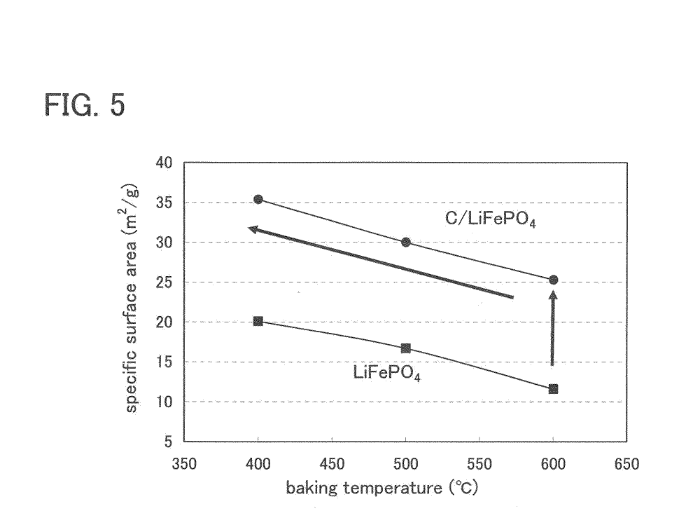

FIG. 5 shows a relation between a baking temperature and the specific surface area of lithium iron phosphate particles which are shown in FIGS. 1A to 1C and FIGS. 2A to 2C and manufactured by setting the second baking temperature at 600° C., 500° C., and 400° C.

Note that the specific surface area of lithium iron phosphate is the specific surface area measured by a BET (Brunauer-Emmett-Teller) method.

In FIG. 5, C/LiFePO₄ indicated by black circles shows the specific surface area of lithium iron phosphate particles whose surface is supported by a carbon material, and LiFePO₄ indicated by black squares shows the specific surface area of lithium iron phosphate particles whose surface is not supported by a carbon material. FIG. 5 shows that the specific surface area is increased as the baking temperature is lowered. Further, FIG. 5 also shows that the specific surface area is increased by covering LiFePO₄ with a carbon material.

The lithium iron phosphate particles manufactured in this embodiment are formed under such manufacturing conditions and using such raw materials as to have the same density. In the particles having the same density, the larger the specific surface area is, the smaller the particle size is. Thus, also in the lithium iron phosphate particles of this embodiment, the larger the specific surface area is, the smaller the particle size is.

FIG. 5 shows that the particle size is reduced as the baking temperature is decreased, and the particle size is reduced by supporting the surface of lithium iron phosphate particles with a carbon material.

### <Change by Baking Time>

The result of evaluating lithium iron phosphate particles, which are manufactured with the baking temperature changed, by X-ray diffraction, measurement of the specific surface area, and a SEM photograph is illustrated below.

### <Baking Time—X-Ray Diffraction>

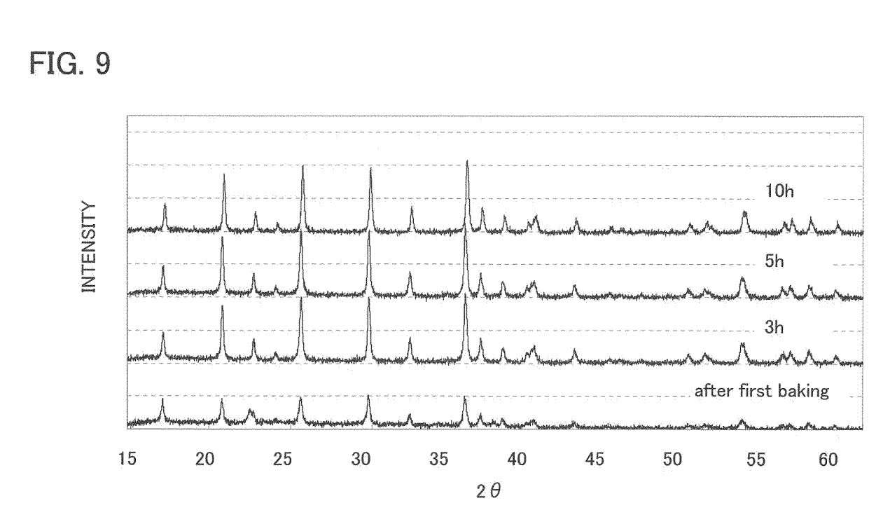

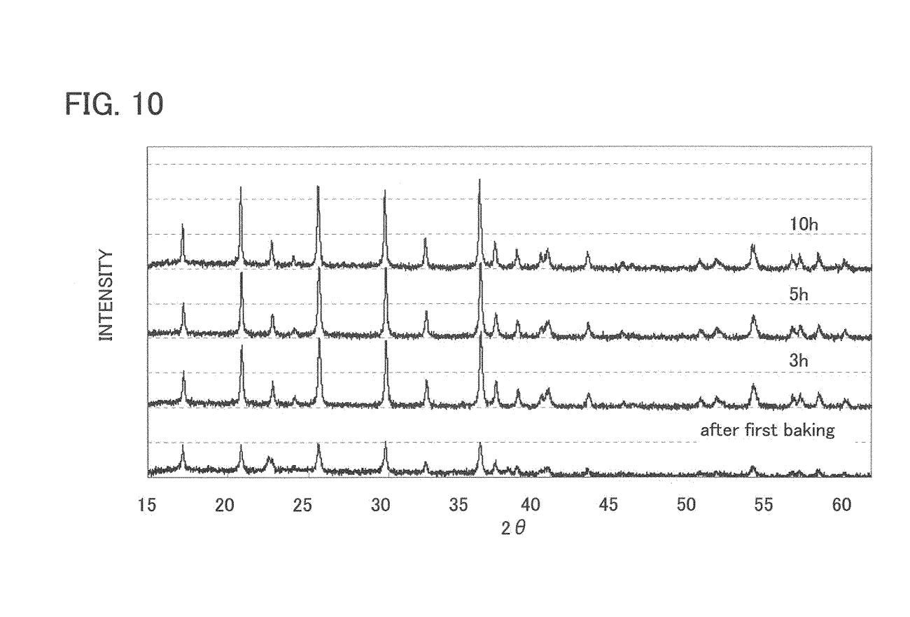

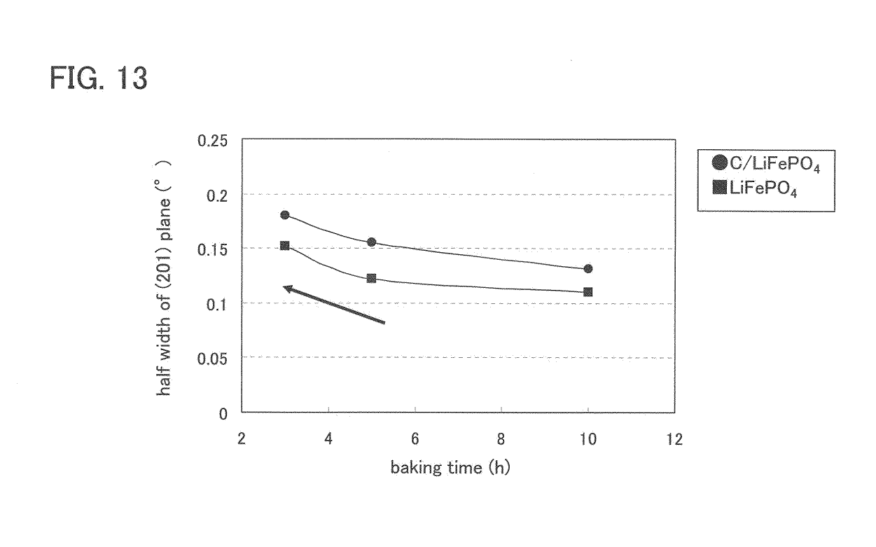

The result of X-ray diffraction of lithium iron phosphate particles manufactured with the baking time changed is illustrated in FIG. 9, FIG. 10, and FIG. 13. The graph of FIG. 7 showing a baking temperature of 600° C. is the same as the graph of FIG. 9 showing baking time of 10 hours.

FIG. 9 shows the result of X-ray diffraction of lithium iron phosphate particles whose surface is supported by a carbon material. In the second baking, baking time is set to 3 hours, 5 hours, and 10 hours. Note that the baking temperature is 600° C.

In FIG. 9, a peak of 2θ=25° can be observed. This is the peak of lithium iron phosphate (201) plane. From this, it is confirmed that the samples measured by X-ray diffraction of FIG. 9 are olivine-type lithium iron phosphate having the (201) plane.

FIG. 10 shows the result of X-ray diffraction of lithium iron phosphate particles whose surface is not supported by a carbon material. In the second baking, baking time is set to 3 hours, 5 hours, and 10 hours. Note that the baking temperature is 600° C.

In FIG. 10, a peak of 2θ=25° can be observed. This is a peak of lithium iron phosphate (201) plane. From this, it is confirmed that the samples measured by X-ray diffraction of FIG. 10 are olivine-type lithium iron phosphate having the (201) plane.

FIG. 13 shows a relation between baking time (X axis) which is set to 3 hours, 5 hours, and 10 hours and a half width of the peak of 2θ=25° (Y axis) in the case of lithium iron phosphate particles whose surface is supported by a carbon material (C/LiFePO₄ indicated by black circles) and in the case of lithium iron phosphate particles whose surface is not supported by a carbon material (LiFePO₄ indicated by black squares).

In FIG. 13, the shorter the baking time is, the larger the half width becomes. That is, the shorter the baking time is, the lower the crystallinity becomes. Note that the relation between the half width and the characteristics of a secondary battery is described below.

Further, in FIG. 7, FIG. 8, FIG. 9, and FIG. 10, the samples are measured by X-ray diffraction measurement at the time of terminating the first baking. In each of FIG. 7, FIG. 8, FIG. 9, and FIG. 10, the peak of 2θ=25° is confirmed at the time of terminating the first baking. From this, it is confirmed that lithium iron phosphate having an olivine structure is manufactured by the first baking.

When the X-ray diffraction peak after the first baking is compared with the X-ray diffreaction peak after the second baking, the peak after the second baking is sharper and the strength of the peak is large. That is, crystalline components of lithium iron phosphate are increased by the second baking, in other words, crystallization proceeds.

### <Baking Time—SEM Photograph>

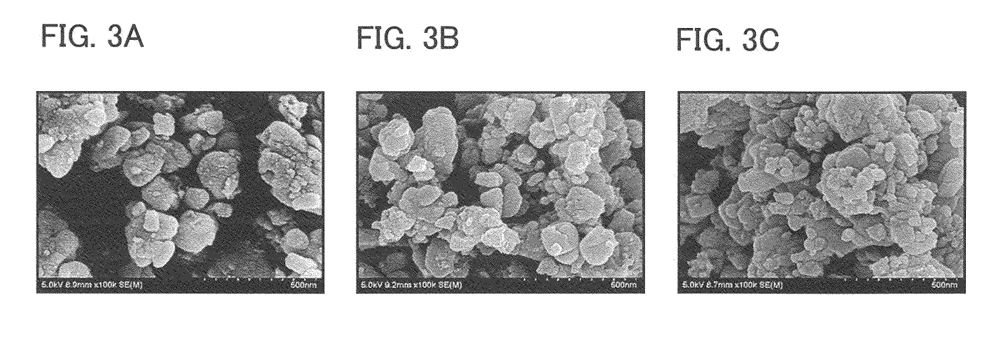

FIGS. 3A to 3C show SEM photographs of lithium iron phosphate particles whose surface is supported by a carbon material and which are manufactured in such a way that the baking time in the second baking is set to 10 hours, 5 hours, and 3 hours.

From FIGS. 3A to 3C, it can be confirmed that the shorter the baking time is, the smaller the particle size of lithium iron phosphate becomes.

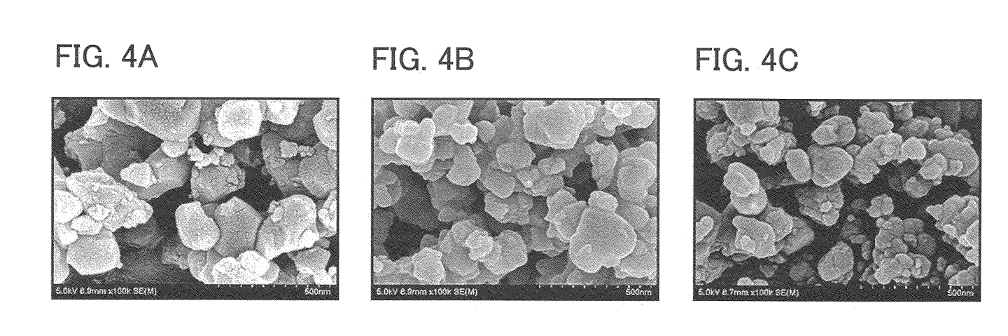

FIGS. 4A to 4C show SEM photographs of lithium iron phosphate particles whose surface is not supported by a carbon material and which are manufactured in such a way that baking time in the second baking is set to 10 hours, 5 hours, and 3 hours.

From FIGS. 4A to 4C, it can be confirmed that the shorter the baking time is, the smaller the particle size of lithium iron phosphate becomes.

### <Baking Time-Specific Surface Area>

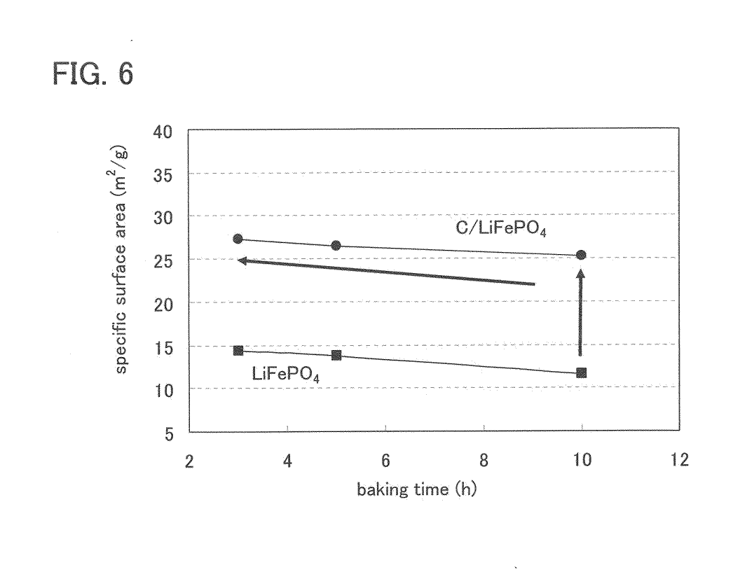

FIG. 6 shows a relation between baking time and the specific surface area of lithium iron phosphate particles which are shown in FIGS. 3A to 3C and FIGS. 4A to 4C and manufactured by setting the second baking time to 10 hours, 5 hours, or 3 hours.

In FIG. 6, C/LiFePO₄ indicated by black circles shows the specific surface area of lithium iron phosphate particles whose surface is supported by a carbon material, and LiFePO₄ indicated by black squares shows the specific surface area of lithium iron phosphate particles whose surface is not supported by a carbon material. FIG. 6 shows that the specific surface area is increased as the baking time is decreased. Further, FIG. 6 also shows that the specific surface area is increased by covering LiFePO₄ with a carbon material.

FIG. 6 shows that the particle size becomes smaller as the baking time becomes shorter, and the particle size becomes smaller by supporting the surface of lithium iron phosphate particles with a carbon material.

By comparing FIG. 5 and FIG. 6, it is found that the specific surface area is more increased by lowering baking temperature than by shortening baking time.

### <Amount of Glucose to be Added>

The result of evaluating lithium iron phosphate particles, which are manufactured with the amount of glucose to be added changed, by a SEM photograph and measurement of the specific surface area is illustrated below.

### <Amount of Glucose to be Added—SEM Photograph>

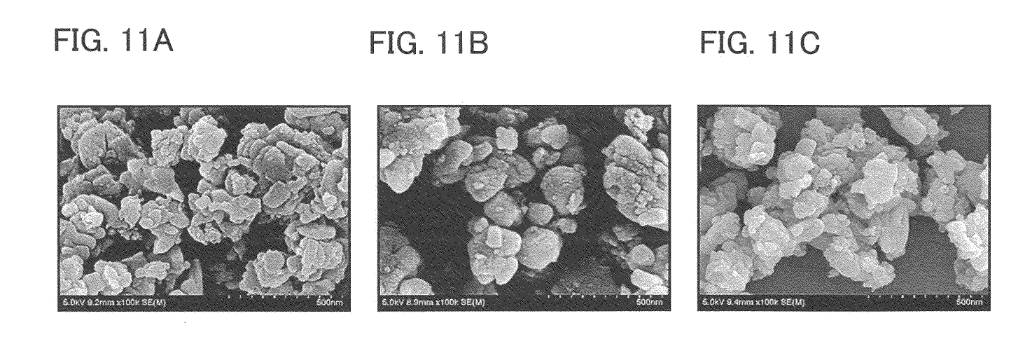

FIGS. 11A to 11C show SEM photographs of lithium iron phosphate particles manufactured by setting the amount of glucose to be added to 15 wt %, 10 wt %, and 15 wt %.

### <Amount of Glucose to be Added—Specific Surface Area>

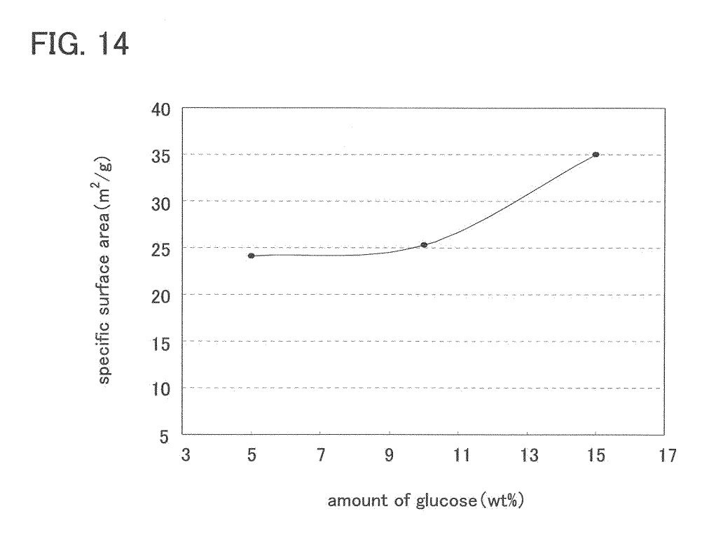

FIG. 14 shows a relation between the amount of glucose to be added and the specific surface area of lithium iron phosphate particles which are shown in FIGS. 11A to 11C and manufactured by setting the amount of glucose to 15 wt %, 10 wt %, and 5 wt %.

In FIG. 14, the specific surface area of lithium iron phosphate particles to which 5 wt % and 10 wt % of glucose is added is almost the same, and the specific surface area of lithium iron phosphate particles to which 15 wt % of glucose is added is larger than the specific surface area of lithium iron phosphate particles to which 5 wt % and 10 wt % of glucose is added.

A secondary battery including lithium iron phosphate particles manufactured as described above, a manufacturing method thereof, and characteristics of the secondary battery are described below.

### <Manufacturing Method of Secondary Battery>

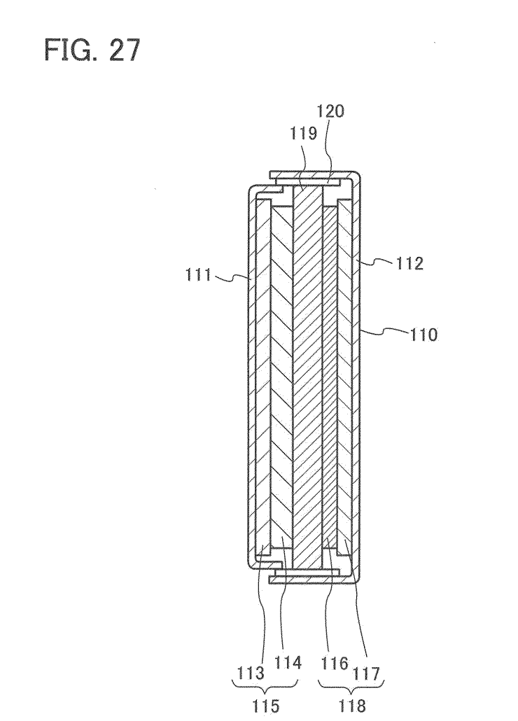

A cross-sectional view of a secondary battery which is manufactured is illustrated in FIG. 27. A secondary battery 110 includes a positive electrode 115 having a positive electrode current collector 113 and a positive electrode active material layer 114, a negative electrode 118 having a negative electrode current collector 117 and a negative electrode active material layer 116, and an electrolyte between the positive electrode 115 and the negative electrode 118.

The positive electrode current collector 113 can be formed using a conductive material such as aluminum, copper, nickel, or titanium, for example. Also, the positive electrode current collector 113 can be formed using an alloy material containing a plurality of the above-mentioned conductive materials, such as an Al—Ni alloy, or an Al—Cu alloy, for example. The positive electrode current collector 113 can be formed using a conductive layer which has been separately formed over a substrate and then separated from the substrate.

The positive electrode active material layer 114 may be formed by mixing lithium iron phosphate particles and a conduction auxiliary agent (e.g., acetylene black: AB), a binder (e.g., polyvinylidene difluoride: PVDF), or the like so as to be a paste, and then applying it on the positive electrode current collector 113, or by a sputtering method. In the case of forming the positive electrode active material layer 114 by a coating method, the positive electrode active material layer 114 may be molded as necessary by applying pressure.

Note that “active material” refers only to a material that relates to injection and extraction of ions functioning as carriers. That is, in this embodiment, the positive electrode active material is only lithium iron phosphate. In this specification, in the case where the positive electrode active material layer 114 is formed using a coating method, for the sake of convenience, the positive electrode active material layer 114 will collectively refer to the material of the positive electrode active material layer 114, that is, the material that is actually a “positive electrode active material” (lithium iron phosphate in this embodiment) and the conduction auxiliary agent, the binder, or the like.

Note that as the conductive auxiliary agent, an electron-conductive material which does not cause chemical change in the power storage device may be used. For example, a carbon material such as graphite or carbon fibers, a metal material such as copper, nickel, aluminum, or silver, or a powder or a fiber of a mixture thereof can be used.

It is to be noted that as a material of the binder, polysaccharides, thermoplastic resins, polymers with rubber elasticity or the like can be used. As an example of these material, starch, carboxymethyl cellulose, hydroxypropyl cellulose, regenerated cellulose, diacetyl cellulose, polyvinyl chloride, polyvinyl pyrrolidone, polytetrafluoroethylene, polyvinylide fluoride, polyethylene, polypropylene, ethylene-propylene-diene monomer (EPDM), sulfonated EPDM, styrene-butadiene rubber, butadiene rubber, or fluorine rubber or the like can be given. Further, polyvinyl alcohol, polyethylene oxide or the like may be used.

As the negative electrode current collector 117, a simple substance, such as copper (Cu), aluminum (Al), nickel (Ni), or titanium (Ti), or a compound thereof may be used.

As a material of the negative electrode active material layer 116, a material capable of occlusion and release of alkali metal ions, alkaline earth metal ions, beryllium ions, or magnesium ions, such as an alkali metal compound, an alkaline earth metal compound, a beryllium compound, or a magnesium compound is used. As an example of the material capable of occlusion and release of alkali metal ions, alkaline earth metal ions, beryllium ions, or magnesium ions, carbon, silicon, silicon alloy, or the like is given. As an example of carbon capable of occlusion and release of alkali metal ions, alkaline earth metal ions, beryllium ions, or magnesium ions, a carbon material such as a fine graphite powder or a graphite fiber is given.

As an example of the alkali metal, lithium, sodium, or potassium can be given here. Further, as an example of an alkaline earth metal, calcium, strontium, or barium is given.

In this embodiment, aluminum foil is used as the positive electrode current collector 113 and a mixture of lithium iron phosphate particles, a conduction auxiliary agent, and a binder is applied on the positive electrode current collector 113 as the positive electrode active material layer 114.

The negative electrode active material layer 116 may be formed by mixing the above-described materials, a conduction auxiliary agent (e.g., acetylene black: AB), a binder (e.g., polyvinylidene difluoride: PVDF), or the like to be a paste, and then applying it on the negative electrode current collector 117, or by a sputtering method. In the case of forming the negative electrode active material layer 116 by a coating method, the negative electrode active material layer 116 may be molded as necessary by applying pressure.

Note that “active material” refers only to a material that relates to injection and extraction of ions functioning as carriers. That is, in this embodiment, the negative electrode active material is only a material capable of insertion and extraction of alkali metal ions, alkaline earth metal ions, beryllium ions, or magnesium ions, such as an alkali metal compound, an alkaline earth metal compound, a beryllium compound, or a magnesium compound. In this specification, in the case where the negative electrode active material layer 116 is formed using a coating method, for the sake of convenience, the negative electrode active material layer 116 will collectively refer to the material of the negative electrode active material layer 116, that is, the material that is actually a “negative electrode active material,” and the conduction auxiliary agent, the binder, or the like.

After forming the positive electrode 115 and the negative electrode 118, an electrolyte is formed between the positive electrode 115 and the negative electrode 118.

In the secondary battery 110 in FIG. 27, a separator 119 provided between the positive electrode 115 and the negative electrode 118 is impregnated with an electrolyte solution, which is a liquid electrolyte.

The electrolyte solution contains alkali metal ions, alkaline earth metal ions, beryllium ions, or magnesium ions, which are carrier ions, and these ions are responsible for electrical conduction. As examples of alkali metal ions, lithium ions, sodium ions, and potassium ions are given. As examples of alkaline earth metal ions, calcium ions, strontium ions, and barium ions are given.

The electrolyte solution contains, for example, a solvent and a lithium salt or a sodium salt dissolved therein. As an example of a lithium salt, lithium chloride (LiCl), lithium fluoride (LiF), lithium perchlorate (LiClO₄), lithium tetrafluoroborate (LiBF₄), LiAsF₆, LiPF₆, Li(C₂F₅SO₂)₂N, or the like can be given. As an example of a sodium salt, sodium chloride (NaCl), sodium fluoride (NaF), sodium perchlorate (NaClO₄), sodium tetrafluoroborate (NaBF₄), or the like can be given.

Examples of the solvent for the electrolyte solution include cyclic carbonates such as ethylene carbonate (hereinafter abbreviated as EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), methylpropyl carbonate (MPC), methylisobutyl carbonate (MIBC), and dipropyl carbonate (DPC); aliphatic carboxylic acid esters such as methyl formate, methyl acetate, methyl propionate, and ethyl propionate; γ-lactones such as γ-butyrolactone; acyclic ethers such as 1,2-dimethoxyethane (DME), 1,2-diethoxyethane (DEE), and ethoxymethoxy ethane (EME); cyclic ethers such as tetrahydrofuran and 2-methyltetrahydrofuran; dimethylsulfoxide; 1,3-dioxolane and the like; alkyl phosphate esters such as trimethyl phosphate, triethyl phosphate, and trioctyl phosphate and fluorides thereof, all of which can be used either alone or in combination

As the separator 119, paper, nonwoven fabric, a glass fiber, a synthetic fiber such as nylon (polyamide), vinylon (a polyvinyl alcohol based fiber), polyester, acrylic, polyolefin, or polyurethane, or the like may be used. However, a material which does not dissolve in an electrolyte solution should be selected.

More specific examples of materials for the separator 119 are high-molecular compounds based on fluorine-based polymer, polyether such as a polyethylene oxide and a polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, and nonwoven fabric, all of which can be used either alone or in a combination.

In the case of the secondary battery 110 illustrated in FIG. 27, the separator 119 is preferably a porous film. As a material of the porous film, a synthetic resin substance, a ceramic substrate, or the like may be used. As examples of the material of the porous film, polyethylene, polypropylene, or the like can be preferably used.

The secondary battery 110 manufactured in this manner can have various structures, such as a coin-type structure, a laminate-type structure, or a cylinder-type structure.

A specific method for manufacturing the secondary battery 110 of this embodiment is described below.

The lithium iron phosphate particles obtained as described above, the conductive agent, the binder, and the solvent are mixed together and are dispersed using a homogenizer or the like. The dispersed material is applied on the positive electrode current collector 113 and dried, whereby the positive electrode active material layer 114 is obtained.

In this embodiment, aluminum (Al) foil is used as the positive electrode current collector. Further, in this embodiment, acetylene black (AB) is used as a conduction auxiliary agent; polyvinylidene difluoride (PVDF) is used as a binder; and N-Methyl-2-Pyrrolidone (N-MethylPyrrolidone: NMP) is used as a solvent.

Pressure is applied to the dried material, and the shape of the dried material is arranged, whereby the positive electrode is formed. Specifically, pressure is applied with a roll press so that the film thickness is about 50 μm and the amount of the lithium iron phosphate is about 3 mg/cm², and punching is performed on the material to have a round shape of φ12 mm, whereby the positive electrode 115 of the lithium ion secondary battery is obtained.

Further, in this embodiment, lithium foil is used for the negative electrode, and polypropylene (PP) is used for the separator 119. For the electrolyte solution, ethylene carbonate (EC) and dimethyl carbonate (DC) in which lithium hexafluorophosphate (also referred to as lithium hexafluorophosphate (LiPF₆)) is dissolved are used. The separator 119 is impregnated with an electrolyte solution.

The above-described negative electrode 118 and the separator 119 impregnated with the electrolyte solution are installed in a housing 112. Then, a ring-shaped insulator 120 is installed around the separator 119 and the negative electrode 118.

The ring-shaped insulator 120 has a function of insulating the positive electrode 115 from the negative electrode 118. Further, the ring-shaped insulator 120 is preferably formed using an insulating resin.

Further, the positive electrode 115 is installed in the housing 111. The housing 111 in which the positive electrode 115 is installed is turned upside down so as to be installed in the housing 112 in which the ring-shaped insulator 120 is provided.

As described above, the positive electrode 115 is insulated from the negative electrode 118 by the ring-shaped insulator 120, so that a short circuit is prevented.

In the above-described manner, a coin-type lithium ion secondary battery including the positive electrode 115, the negative electrode 118, the separator 119, and the electrolyte solution is obtained. Battery assembly such as the positive electrode 115, the negative electrode 118, the separator 119, and the electrolyte solution is performed in a gloved box with an argon atmosphere.

### <Characteristic of Secondary Battery>

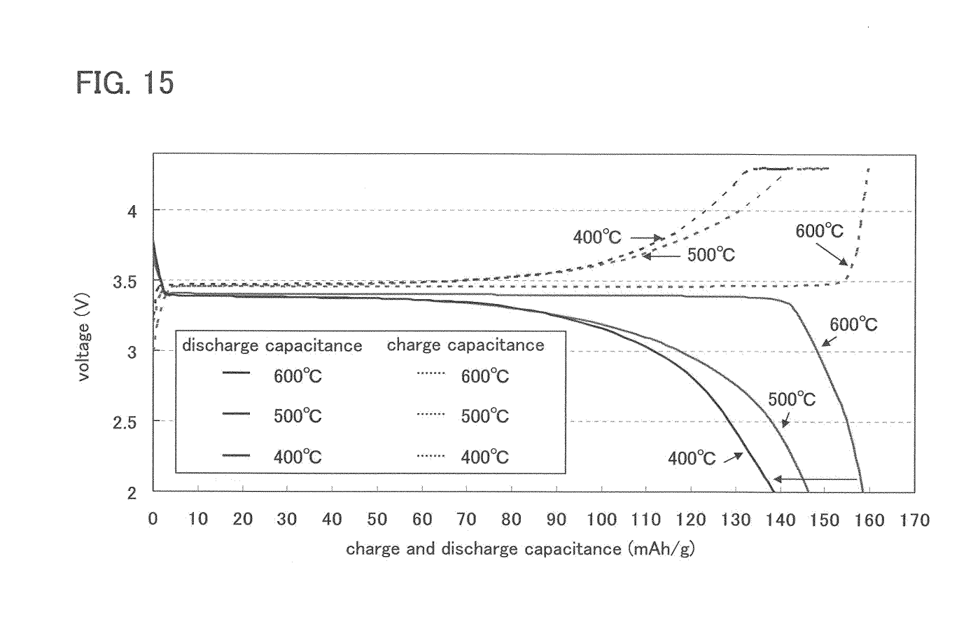

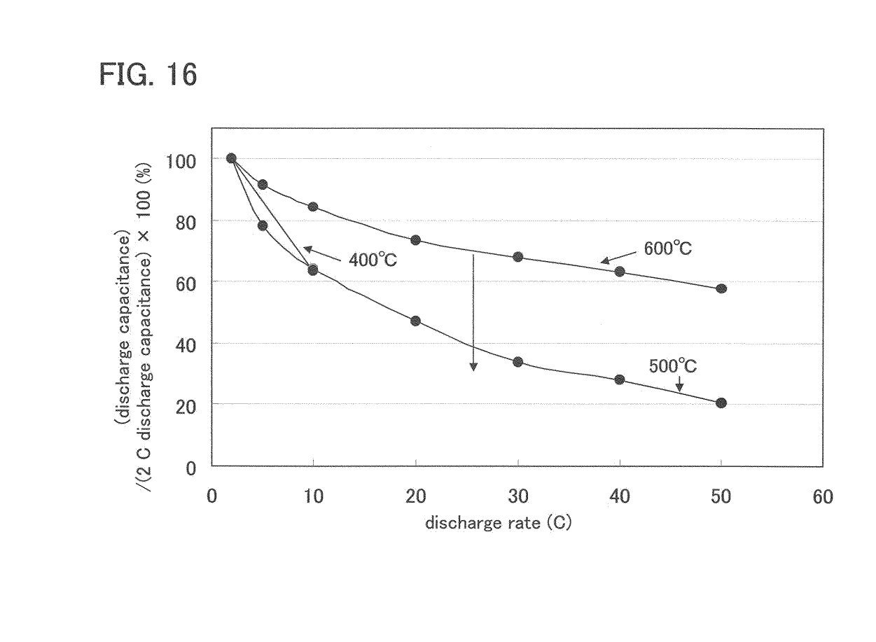

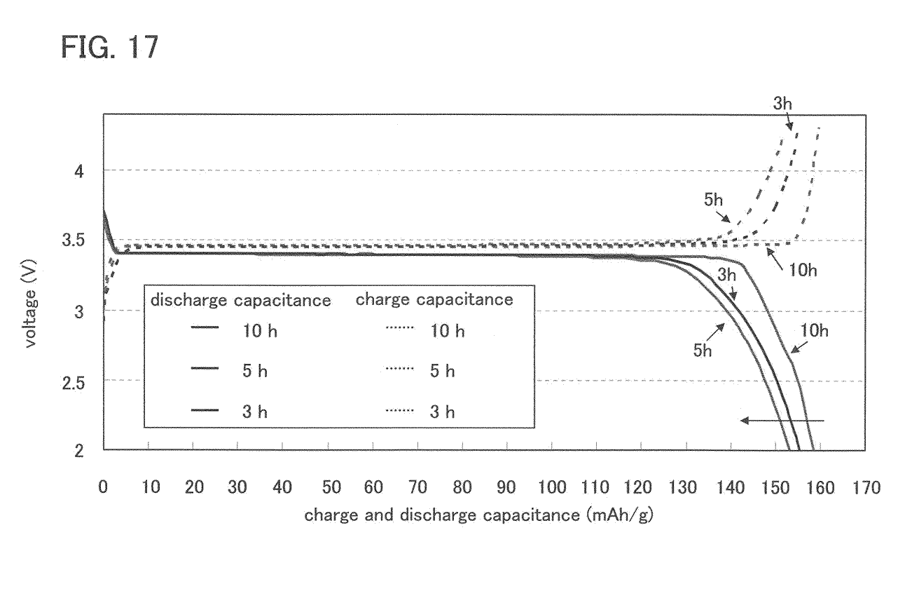

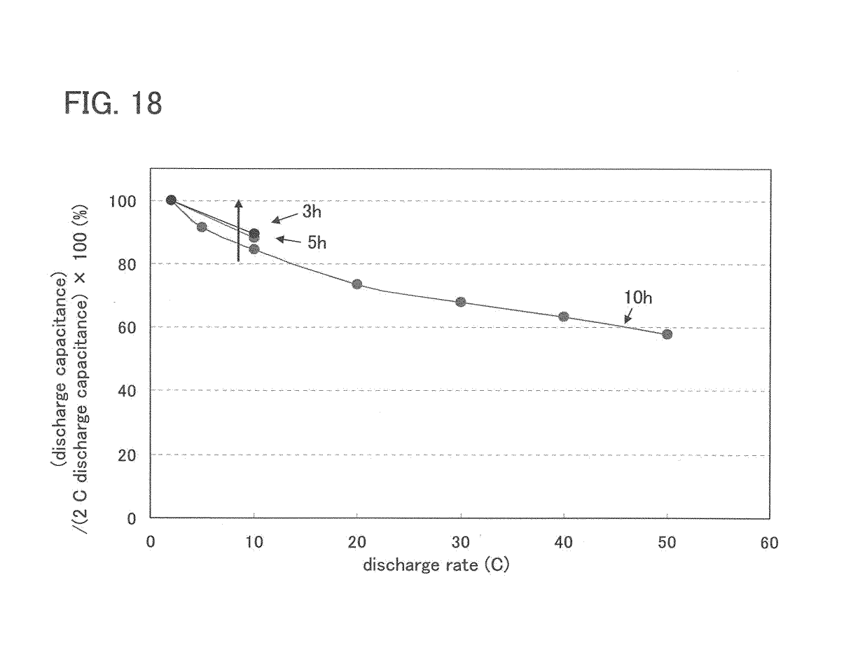

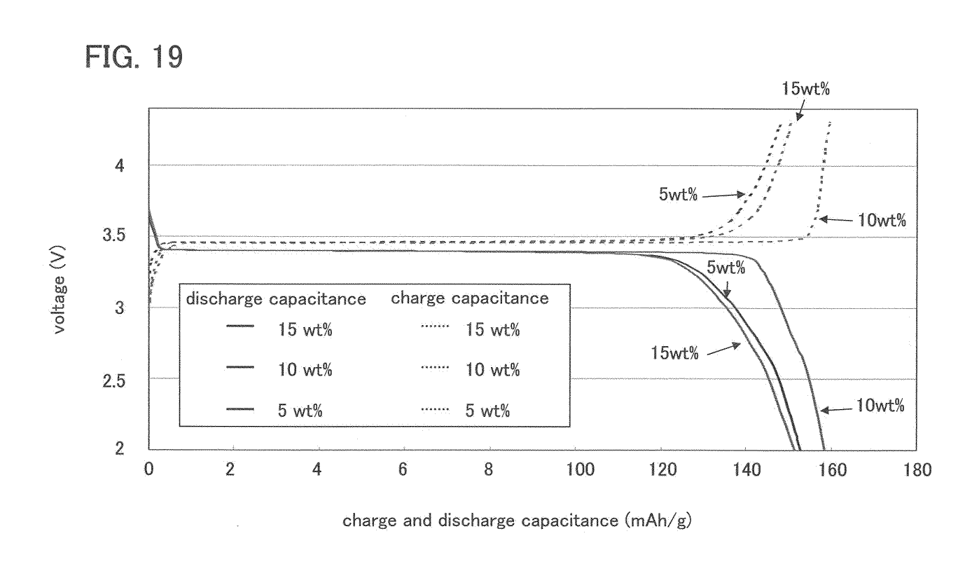

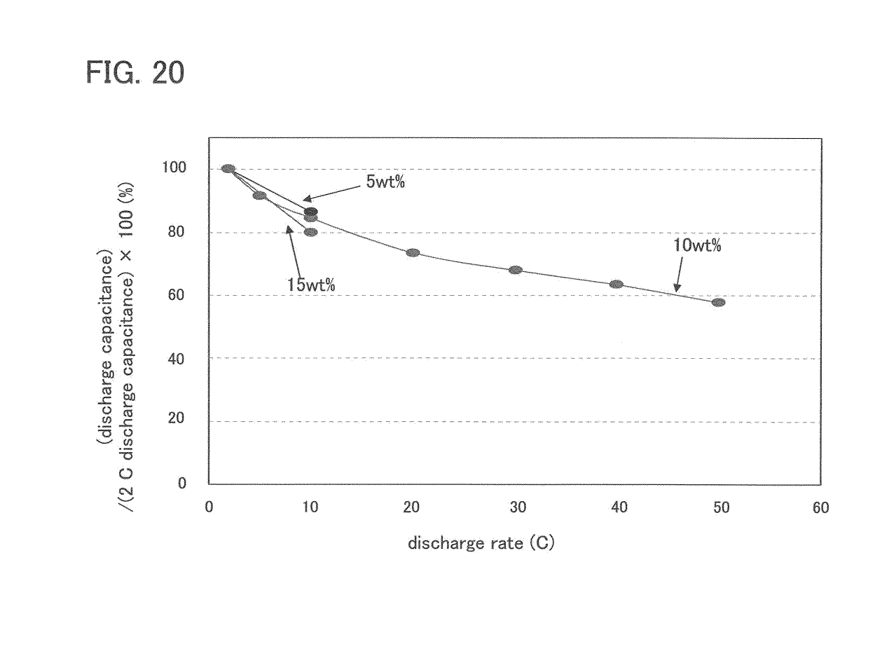

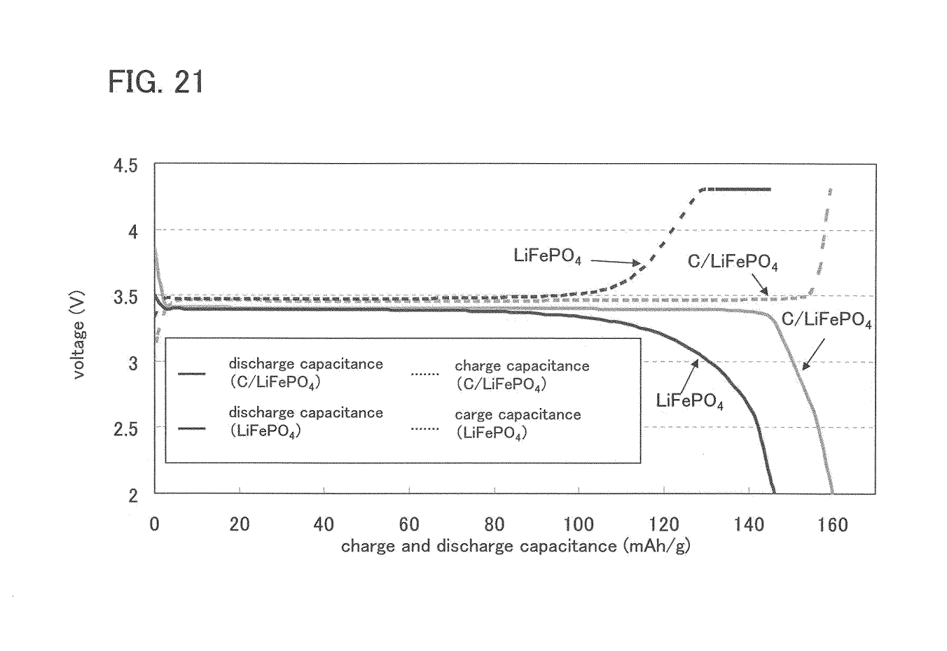

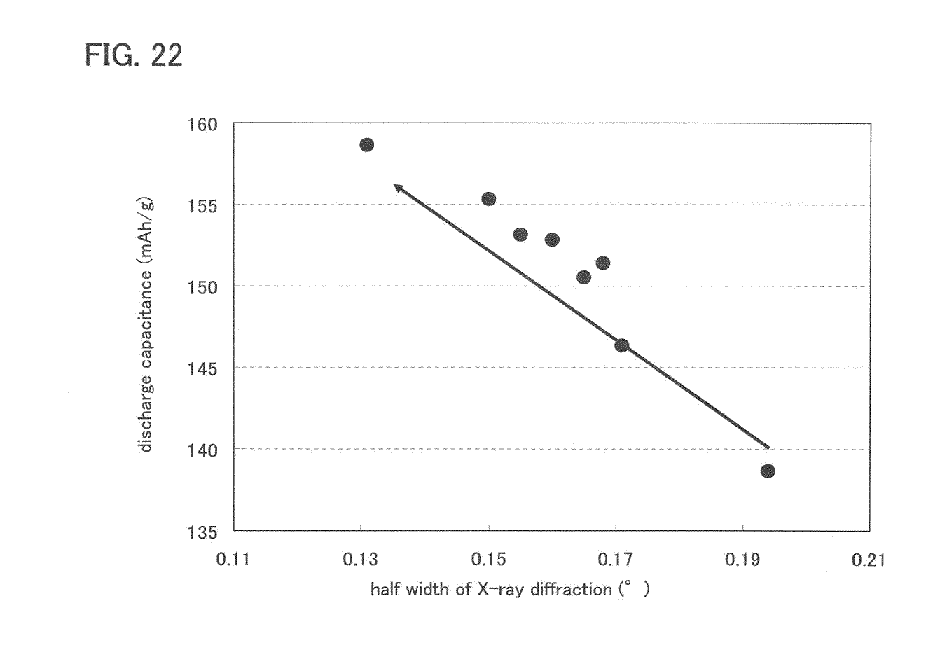

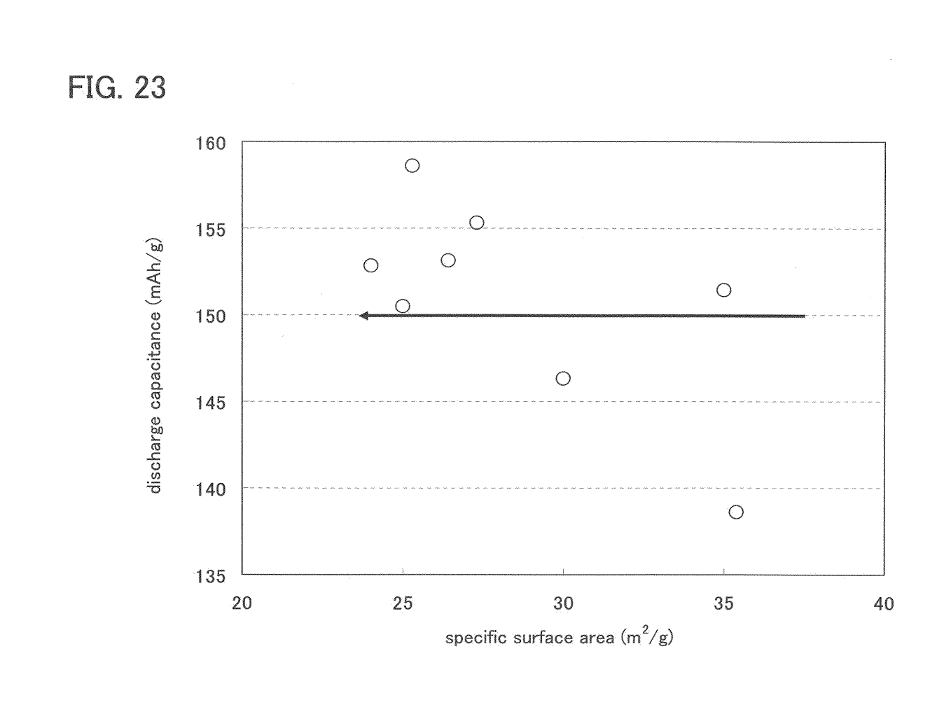

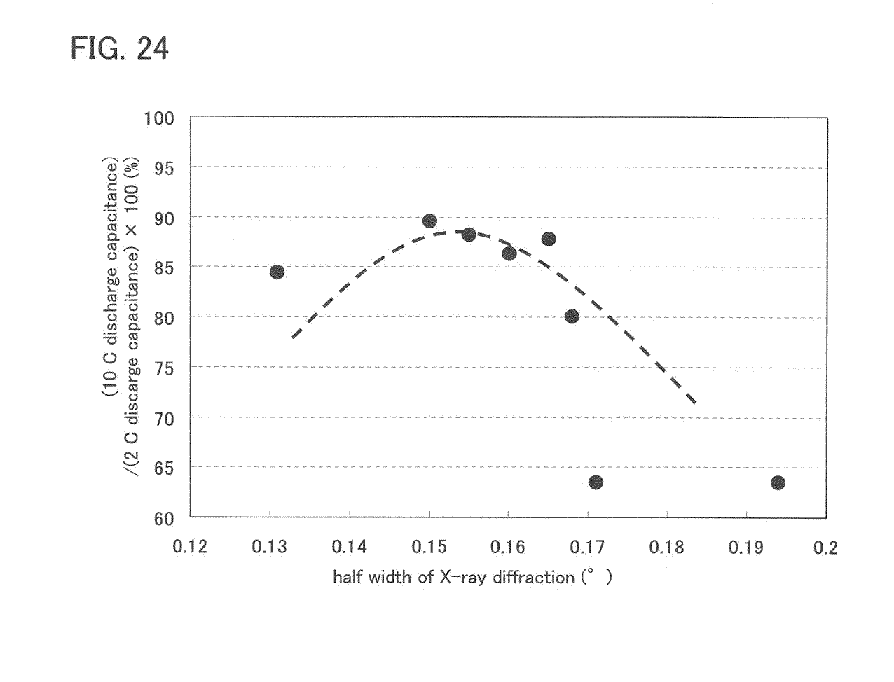

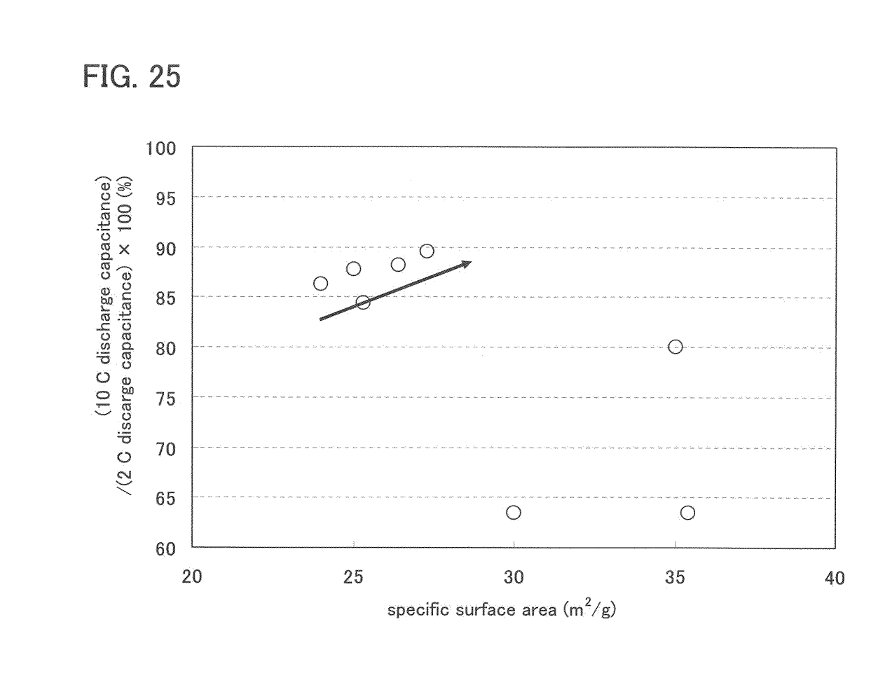

Characteristics of the obtained coin-type lithium ion secondary battery is illustrated in FIG. 15, FIG. 16, FIG. 17, FIG. 18, FIG. 19, FIG. 20, FIG. 21, FIG. 22, FIG. 23, FIG. 24, and FIG. 25.

### <Change by Baking Temperature>

Shown is evaluation of the characteristics of secondary batteries including lithium iron phosphate particles manufactured with the baking temperature changed.

### <Baking Temperature—Charge and Discharge Characteristic>

FIG. 15 shows charge and discharge characteristics of lithium ion secondary batteries including a positive electrode using lithium iron phosphate particles whose surface is supported by a carbon material and which are manufactured with the baking temperature of the second baking set at 600° C. (red), 500° C. (green), and 400° C. (blue). Note that a solid line shows a relation between discharge capacitance and voltage, and a dotted line shows a relation between charge capacitance and voltage.

Note that a charge and discharge test is conducted at a rate of 0.2 C with constant current drive/constant voltage drive (CCVC drive). Further, the solid line shows a discharge curve and the dotted line shows a charge curve. The condition of the charge and discharge test described below is the same.

FIG. 15 shows that discharge capacitance and charge capacitance are decreased as the baking temperature is lowered.

### <Baking Temperature—Rate Characteristic>

FIG. 16 shows rate characteristics of lithium ion secondary batteries including a positive electrode using lithium iron phosphate particles whose surface is supported by a carbon material and which are manufactured with the baking temperature of the second baking set at 600° C. (red), 500° C. (green), and 400° C. (blue).

In FIG. 16, X axis (the horizontal axis) represents a discharge rate at which the secondary battery is discharged after the secondary battery is charged at a charge rate of 0.2 C (note that X is 0 C or more). The charge rate of 0.2 C means the secondary battery is charged 0.2 times an hour, in other words, it takes five hours for the secondary battery to be charged once.

Further, Y axis (the vertical axis) in FIG. 16 is a percentage of discharge capacitance with respect to discharge capacitance in the case where a discharge rate is 2 C. The charge rate of 2 C means the secondary battery is discharged twice an hour, in other words, it takes 30 minutes for the secondary battery to be discharged once.

That is, Y axis in FIG. 16 shows how much discharge capacitance is decreased with discharge capacitance in the case where the discharge rate is 2 C used as a reference (100%).

As described above, FIG. 16 is a graph showing how much discharge capacitance is decreased in accordance with an increase in the discharge rate.

When the discharge rate is increased, it is hard to keep a speed of injection and extraction of lithium ions into/from the lithium iron phosphate particles, that is, a speed of diffusion; accordingly, discharge capacitance is decreased. Thus, it can be said that the measurement as shown in FIG. 16 is measurement showing a diffusion rate of lithium ions.

Conversely, the discharge capacitance is not decreased even in the case where the discharge rate is increased, and it means that the diffusion rate of lithium ions is not decreased.

FIG. 16 shows that the discharge capacitance is decreased when the baking temperature is decreased even in the case where the discharge rate is the same.

### <Change by Baking Time>

Shown is evaluation of the characteristics of secondary batteries including lithium iron phosphate particles manufactured with baking time changed.

### <Baking Time—Charge and Discharge Characteristics>

FIG. 17 shows charge and discharge characteristics of lithium ion secondary batteries including a positive electrode using lithium iron phosphate particles whose surface is supported by a carbon material and which are manufactured with baking time of the second baking set to 10 hours (red), 5 hours (green), and 3 hours (blue). Note that a solid line shows a relation between discharge capacitance and voltage, and a dotted line shows a relation between charge capacitance and voltage.

FIG. 17 shows that discharge capacitance and charge capacitance are the largest when the baking time is 10 hours, which is the longest baking time. On the other hand, discharge capacitance and charge capacitance are decreased when baking time is 5 hours and 3 hours.

Specifically, when the baking time is 10 hours, the discharge capacitance is as large as 160 mAh/g.

Furthermore, FIG. 21 shows a comparison of charge and discharge capacitance characteristics between a lithium ion secondary battery in which lithium iron phosphate particles (C/LiFePO₄ represented by orange) whose surface is supported by a carbon material supported are used for a positive electrode and a lithium ion secondary battery in which lithium iron phosphate particles (LiFePO₄ represented by purple) whose surface is not supported by a carbon material are used for the positive electrode. Note that in each of the lithium ion secondary batteries, the second baking is performed in the following conditions: the baking temperature, 600° C.; the baking time, 10 hours; and the amount of glucose to be added, 10 wt %. Note that a solid line shows a relation between discharge capacitance and voltage, and a dotted line shows a relation between charge capacitance and voltage.

In FIG. 21, the discharge capacitance of the lithium ion secondary battery using lithium iron phosphate particles whose surface is supported by a carbon material is 160 mAh/g, and the discharge capacitance of the lithium ion secondary battery using lithium iron phosphate particles whose surface is not supported by a carbon material is 140 mAh/g.

As mentioned above, the theoretical capacity of a lithium ion secondary battery is 170 mAh/g. Therefore, the discharge capacitance of the lithium ion secondary battery, that is, the discharge capacitance of the lithium ion secondary battery having lithium iron phosphate particles whose surface is supported by a carbon material and which are manufactured under the conditions of the baking temperature, 600° C.; the baking time, 10 hours; and the amount of glucose to be added, 10 wt %, is found to be close to the theoretical capacity.

That is, diffusion of lithium ions in lithium iron phosphate obtained in this embodiment and a secondary battery using such lithium iron phosphate as a positive electrode active material is 94% of the total (160 mAh/g)/(170 mAh/g)×100(%).

### <Baking Time—Rate Characteristic>

FIG. 18 shows rate characteristics of the lithium ion secondary battery using lithium iron phosphate particles whose surface is supported by a carbon material and which are manufactured with baking time of the second baking set to 10 hours (red), 5 hours (green), and 3 hours (blue).

From FIG. 18, it can be confirmed that a ratio how much the discharge capacitance is decreased is diminished as the baking time is shortened even in the case where the discharge rate is the same.

Specifically, in FIG. 18, the secondary battery using lithium iron phosphate particles in the case where the baking time is 3 hours has a ratio of discharge capacitance with respect to discharge capacitance in the case of where the discharge rate is 2 C (discharge capacitance/2 C discharge capacitance (Y axis)) as large as 89.5% when the discharge rate (X axis) is 10 C.

### <Amount of Glucose to be Added>

Shown is evaluation of the characteristics of secondary batteries including lithium iron phosphate particles manufactured with amount of glucose to be added changed.

### <Amount of Glucose to be Added—Charge and Discharge Characteristic>

FIG. 19 shows charge and discharge characteristics of lithium ion secondary batteries including a positive electrode using lithium iron phosphate particles whose surface is supported by a carbon material and which are manufactured by setting the amount of glucose to be added to 15 wt % (red), 10 wt % (green), and 5 wt % (blue). Note that solid lines show a relation between discharge capacitance and voltage, and dotted lines show a relation between charge capacitance and voltage.

FIG. 19 shows that discharge capacitance and charge capacitance are the largest when the amount of glucose to be added is 10 wt %. On the other hand, discharge capacitance and charge capacitance are decreased when the amount of glucose to be added is 5 wt % and 10 wt %.

Using FIG. 19 and FIG. 14, the lithium iron phosphate particles to which 5 wt % of glucose is added is compared with the lithium iron phosphate particles to which 10 wt % of glucose is added. Although FIG. 14 shows that the specific surface area of lithium iron phosphate particles to which 5 wt % of glucose is added is almost the same as that of lithium iron phosphate particles to which 10 wt % of glucose is added, FIG. 19 shows that the discharge capacitance and charge capacitance of lithium iron phosphate particles to which 5 wt % of glucose is added are smaller than those of lithium iron phosphate particles to which 10 wt % of glucose is added.

As described above, lithium iron phosphate particles manufactured in this embodiment are formed under such manufacturing conditions and using such raw materials as to have the same density. In the particles having the same density, the larger the specific surface area is, the smaller the particle size is. Thus, also in the lithium iron phosphate particles of this embodiment, the larger the specific surface area is, the smaller the particle size is.

Further, it can be considered that the particle size of lithium iron phosphate particles is almost the same when the lithium iron phosphate particles have almost the same specific surface area. That is, the lithium iron phosphate particles to which 5 wt % and 10 wt % of glucose is added have almost the same specific surface area, and almost the same particle size.

However, although the lithium iron phosphate particles to which 5 wt % and 10 wt % of glucose is added have the almost the same particle size, discharge capacitance and charge capacitance of the lithium iron phosphate particles to which 5 wt % of glucose is added are smaller than those of the lithium iron phosphate particles to which 10 wt % of glucose is added.

When the discharge capacitance and charge capacitance of the lithium iron phosphate particles are different even though the particle size of the lithium iron phosphate is almost the same, it means that conductivity of carbon which covers the lithium iron phosphate particles is different.

That is, when the amount of glucose to be added is small, there are few hydroxy groups which have not been thermally decomposed, whereby the conductivity is decreased.

### <Amount of Glucose to be Added—Rate Characteristic>

FIG. 20 shows rate characteristics of lithium ion secondary batteries including a positive electrode using lithium iron phosphate particles whose surface is supported by a carbon material and which are manufactured by setting the amount of glucose to be added to 15 wt % (red), 10 wt % (green), and 5 wt % (blue).

FIG. 20 shows that discharge capacitance is increased as the amount of glucose to be added is small, even when the discharge rate is the same.

### <Relation Between Half Width and Discharge Capacitance>

FIG. 22 shows a relation between a half width of the X-ray diffraction peak and discharge capacitance. Note that in FIG. 22, half widths of lithium iron phosphate particles manufactured under different manufacturing conditions in baking temperature, baking time, and the amount of glucose to be added, are all considered to be values on the X axis. As described above, the half width of the X-ray diffraction peak represents the degree of crystallinity (the level of crystallinity).

As shown in FIG. 22, as the half width is smaller, that is, as the crystallinity is high, discharge capacitance is large.

Description below is a reason why the discharge capacitance is increased as the crystallinity is improved.

In lithium iron phosphate having an olivine structure, lithium ions diffuse one-dimensionally. Thus, as crystallinity is high, a diffusion path of lithium ions is ensured and insertion and extraction of a large amount of lithium ions is possible.

FIG. 22 shows that the discharge capacitance of the secondary battery having lithium iron phosphate whose half width is greater than 0.17° as a positive electrode active material, is smaller than that of the secondary battery having lithium iron phosphate whose half width is less than or equal to 0.17°. In the lithium iron phosphate whose half width is greater than 0.17°, there is a possibility that the crystal is distorted and the diffusion path in the crystal cannot be maintained. Thus, insertion and extraction of lithium ions are limited and discharge capacitance is decreased.

Accordingly, the secondary battery using as a positive electrode active material, the lithium iron phosphate whose half width of the X-ray diffraction peak is less than or equal to 0.17° is preferable because the discharge capacitance is large.

### <Relation Between Specific Surface Area and Discharge Capacitance>

FIG. 23 shows a relation between the specific surface area and discharge capacitance. The specific surface area is specific surface area measured by a BET method as described above. Note that in FIG. 23, the specific surface area of lithium iron phosphate particles manufactured under different manufacturing conditions in baking temperature, baking time, and the amount of glucose to be added, are all considered to be values on the X axis.

FIG. 23 shows that the discharge capacitance is not changed even when the specific surface area of lithium iron phosphate particles is changed. As described above, in the lithium iron phosphate particles of this embodiment, the larger the specific surface area is, the smaller the particle size is. That is, FIG. 23 shows that discharge capacitance is not changed even when the particle size of lithium iron phosphate particles is changed.

### <Relation Between Half Width and Rate Characteristic>

FIG. 24 shows a relation between a half width of the X-ray diffraction peak and rate characteristics. In this embodiment, the rate characteristics are characteristics of relative discharge capacitance in the case where the discharge rate is 10 C with respect to discharge capacitance in the case where a discharge rate is 2 C. Note that in FIG. 24, the half widths of lithium iron phosphate particles manufactured under different manufacturing conditions in baking temperature, baking time, and the amount of glucose to be added, are all considered to be values on the X axis.

As described above, the half width of the X-ray diffraction peak represents the degree of crystallinity (the level of crystallinity). FIG. 24 shows that lithium iron phosphate particles whose half width is greater than or equal to 0.13° and less than or equal to 0.165° have good rate characteristics.

In particular, a maximum value of a ratio of discharge capacitance in the case where the discharge rate is 10 C with respect to discharge capacitance in the case where a discharge rate is 2 C (10 C discharge capacitance/2 C discharge capacitance) appears in the vicinity of a half width of 0.155°. The existence of the maximum value of the half width means that a maximum value of the degree of crystallinity exists with respect to rate characteristics.

When the degree of crystallinity is too low, grain boundaries between a crystal grain and a crystal grain trap carrier ions, whereby the mobility of carrier ions becomes low. Thus, the rate characteristics become low. On the other hand, when the degree of crystallinity is too high, it takes time for carrier ions included in one crystal grain to come out. Accordingly, the rate characteristics become low.

By using the lithium iron phosphate particles whose half width is greater than or equal to 0.13° and less than or equal to 0.165°, preferably, 0.155°, as a material for the positive electrode active material layer, a secondary battery with good rate characteristics can be obtained.

### <Relation Between Particle Size and Rate Characteristic>

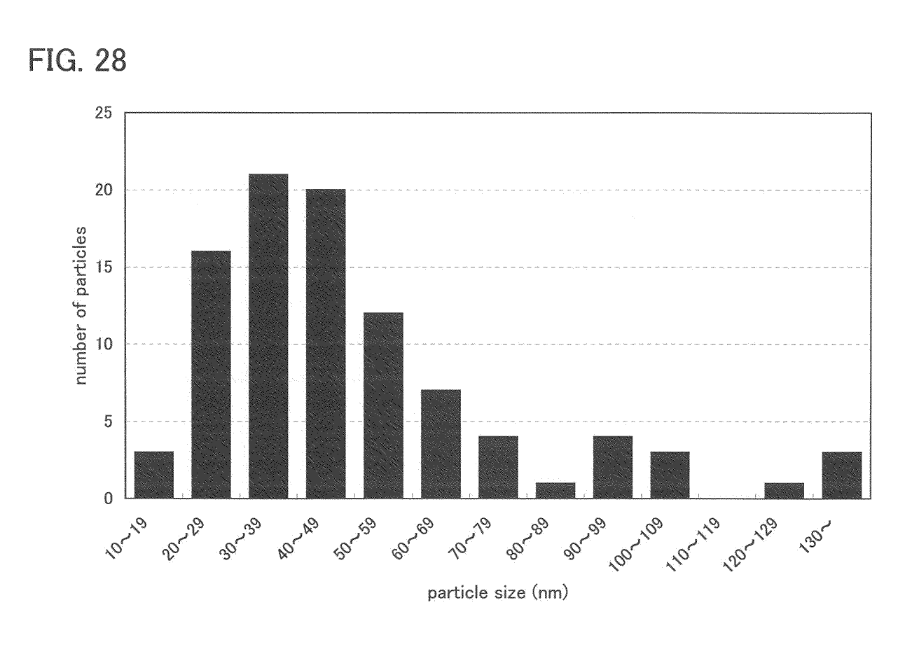

FIG. 28 shows particle size distribution of lithium iron phosphate particles. This is the particle size distribution of lithium iron phosphate particles shown in FIG. 18 which are baked under the conditions of baking time, 3 hours; a baking temperature, 600° C.; and the amount of glucose to be added, 10 wt %. As described above, the secondary battery using the lithium iron phosphate particles has large ratio of discharge capacitance (discharge capacitance/2 C discharge capacitance) (Y axis) of 89.5%. The ratio of discharge capacitance with respect to discharge capacitance in the case where the discharge rate is 2 C (discharge capacitance/2 C discharge capacitance) shows how much discharge capacitance is decreased. Further, how much discharge capacitance is decreased shows the diffusion rate of lithium ions.

In FIG. 28, the number of lithium iron phosphate particles with a particle size of greater than or equal to 20 nm and less than 50 nm is 60% of the total. The particle size of the distribution of the maximum number of particles is in the range of greater than or equal to 30 nm and less than 40 nm. Further, the average value of the particle size is 52 nm and the maximum value is 35 nm. Accordingly, when the particle size is greater than or equal to 20 nm and less than 50 nm, preferably, greater than or equal to 30 nm and less than 40 nm, the diffusion rate of lithium ions is not decreased and a secondary battery with good rate characteristics can be obtained.

### <Relation Between Specific Surface Area and Rate Characteristic>

FIG. 25 shows a relation between the specific surface area and rate characteristics. In FIG. 24, the half widths of samples having lithium iron phosphate particles manufactured under different manufacturing conditions in baking temperature, baking time, and the amount of glucose to be added, are all considered to be values on the X axis. As described above, increase and decrease of the specific surface area is related to increase and decrease of the particle size of the lithium iron phosphate particles.

As shown in FIG. 25, the rate characteristics are better as the specific surface area of lithium iron phosphate particles is larger in the case where the specific surface area is greater than or equal to 20 m²/g and less than or equal to 30 m²/g. This is because a diffusion path of lithium ions is increased when the specific surface area becomes larger.

Alternatively, it can be also said that the rate characteristics get better because the particle size is reduced by having larger specific surface area and diffusion distance between lithium ions is shortened.

Further alternatively, it can be also said that the rate characteristics get better with the both effects of increase in the specific surface area of lithium iron phosphate particles and decrease in the particle size.

According to one embodiment of the invention disclosed above, lithium iron phosphate with low bulk resistivity can be obtained. Further, a power storage device with rapid charge and discharge can be obtained. Furthermore, diffusion of lithium ions can be accelerated. Thus, a power storage device with large capacitance can be obtained.

This application is based on Japanese Patent Application serial no. 2010-065101 filed with Japan Patent Office on Mar. 19, 2010, the entire contents of which are hereby incorporated by reference.

1. A power storage device comprising:
a positive electrode comprising a positive electrode active material layer, the positive electrode active material layer including a lithium iron phosphate particle,
wherein surface of the lithium iron phosphate particle is supported by a carbon material, and
wherein half width of an X-ray diffraction peak of the lithium iron phosphate particle is less than or equal to 0.17°.

2. A power storage device according to claim 1, wherein the half width of the X-ray diffraction peak of the lithium iron phosphate particle is greater than or equal to 0.13° and less than or equal to 0.165°.

3. A power storage device according to claim 1, wherein the X-ray diffraction peak is a peak in a vicinity of 2θ=25°.

4. A power storage device according to claim 1, wherein the lithium iron phosphate particle has an olivine structure.

5. A power storage device comprising:
a positive electrode comprising a positive electrode active material layer, the positive electrode active material layer including a lithium iron phosphate particle,
wherein surface of the lithium iron phosphate particle is supported by a carbon material, and
wherein particle size of the lithium iron phosphate particle is greater than or equal to 20 nm and less than 50 nm.

6. A power storage device according to claim 5, wherein the particle size of the lithium iron phosphate particle is greater than or equal to 30 nm and less than 40 nm.

7. A power storage device according to claim 5, wherein the lithium iron phosphate particle has an olivine structure.

8. A method for manufacturing a power storage device comprising the steps of: mixing a lithium iron phosphate particle, a conduction auxiliary agent, and a binder so as to be a paste; and
applying the paste on a current collector, thereby manufacturing a positive electrode,
wherein surface of the lithium iron phosphate particle is supported by a carbon material, and
wherein half width of an X-ray diffraction peak of the lithium iron phosphate particle is less than or equal to 0.17°.

9. A method for manufacturing a power storage device according to claim 8, wherein the half width of the X-ray diffraction peak of the lithium iron phosphate particle is greater than or equal to 0.13° and less than or equal to 0.165°.

10. A method for manufacturing a power storage device according to claim 8, wherein the X-ray diffraction peak is a peak in a vicinity of 2θ=25°.

11. A method for manufacturing a power storage device according to claim 8, wherein the lithium iron phosphate particle has an olivine structure.

12. A method for manufacturing a power storage device comprising the steps of:
mixing a lithium iron phosphate particle, a conduction auxiliary agent, and a binder so as to be a paste, and
applying the paste on a current collector, thereby manufacturing a positive electrode,
wherein surface of the lithium iron phosphate is supported by a carbon material, and
wherein particle size of the lithium iron phosphate is greater than or equal to 20 nm and less than 50 nm.

13. A method for manufacturing a power storage device according to claim 12, wherein the particle size of the lithium iron phosphate is greater than or equal to 30 nm and less than 40 nm.

14. A method for manufacturing a power storage device according to claim 12, wherein the lithium iron phosphate particle has an olivine structure.
